(19) United States
(12) Patent Application Publication
(10) Pub. No.: US 2021/0196064 A1
(43) Pub. Date: Jul. 1, 2021

(54) Stackable Space Saving Tower

(71) Applicants: James Richard Platt, II, Manor, PA (US); Rebecca Lynn Nesbitt, Manor, PA (US)

(72) Inventors: James Richard Platt, II, Manor, PA (US); Rebecca Lynn Nesbitt, Manor, PA (US)

(21) Appl. No.: 17/180,267

(22) Filed: Feb. 19, 2021

Related U.S. Application Data
(63) Continuation-in-part of application No. 15/998,122, filed on Jul. 2, 2018.
(60) Provisional application No. 62/604,400, filed on Jul. 5, 2017.

(51) Int. Cl. A47G 19/30; A47J 43/24; A47J 47/02

(52) U.S. Cl. CPC A47G 19/30; A47J 47/02; A47J 43/24

(57) ABSTRACT

The present invention, referred to as “STACKABLES,” consists of 3 or 4 bowls/strainers stacked upright using a twist and lock mechanism to raise, lower and lock in place for stability. These molded oval telescopic posts fit into or onto the post molded in the bottom of each bowl/strainer. When upright, the post is secured in an approximately ½ inch oval choke to keep in an elevated position, and when condensed, a 90-degree turn allows the post to slide into or onto the oval post above or below. Each bowl has an accompanying airtight lid.

### CROSS REFERENCE TO RELATED APPLICATIONS

This application is a continuation-in-part of U.S. application Ser. No. 15/998,122, filed Jul. 2, 2018, which claims priority to U.S. Provisional Application No. 62/604,400, filed Jul. 5, 2017, both of which are incorporated herein by reference in their entirety.

### FIELD OF THE INVENTION

The present invention relates to kitchenware and, in particular, relates to a plurality of stackable bowls/strainers which use a twist and lock mechanism to raise, lower or lock the bowls/strainers in place for stability.

### BACKGROUND OF THE INVENTION

The present invention, referred as to “STACKABLES,” is a housewares space saving tower. We saw a problem of cluttered countertops, dining room tables, coffee tables and restaurant and banquet tables not having enough room to prepare meals in the kitchen and also too much space taken up while serving foods/items. Our family of 6 always struggled with having any space at our dinner table and having too many spills due to lack of space. Holidays and family gatherings presented the same problems.

### BRIEF SUMMARY OF THE INVENTION

The present invention provides a space saving tower of stackable bowls, comprised of a plurality of bowls, each of the plurality of bowls capable of stacking upon one another, wherein each of the plurality of bowls has a different diameter, wherein a bowl with the smallest diameter is on top of the tower and a bowl with the largest diameter is on the bottom of the tower, wherein each of the plurality of bowls includes a center post which twists and locks into an adjoining bowl.

The tower may be comprised of four bowls, with the first bowl containing three dividing walls.

In an embodiment, the first and second bowls have a diameter of about 7 inches and are about 3 inches deep; the third bowl has a diameter of about 10 inches and is about 3.5 inches deep; and the fourth bowl has a diameter of about 12 inches and is about 4 inches deep.

Each of the plurality of bowls has a molded closed center post having a hole therein for drainage.

The space saving tower is configured to be upright or collapsible, wherein when the tower is collapsible, all of the bowls fit into the bowl that is located on the bottom. The space saving tower also includes a twist and lock mechanism located on the bottom center of each of the bowls, wherein when the tower is upright, the post is seated in about a 0.5 inch oval choke molded to keep in an elevated position; and when the tower is condensed, a 90-degree turn of the twist and lock mechanism in either direction allows the post of each of the bowls to slide into the post above or below.

In addition, each of the plurality of bowls has an airtight lid to keep food fresh.

STACKABLES space saving tower will increase space while cleaning, preparing, serving and/or storing food or items. Our 3 to 4-tiered tower eliminates cluttered countertops/tables. At the dinner table, STACKABLES holds an entire 3 course meal while taking up ⅓ or more of the table space. This provides ample space to enjoy meals and less spills from an over cluttered table. While hosting a gathering, STACKABLES are used on coffee tables, picnic and banquet tables. The commercial industry will benefit using STACKABLES in the kitchen and while serving patrons at tables. STACKABLES can be used for food or any items needed to save space.

STACKABLES is unique with all levels being independently standing and then built up vertically with simple posts molded into the center each bowl/strainer. Each bowl also comes with an airtight lid to move food from the table, to the refrigerator, to the microwave (if needed) and back to the table for another meal.

STACKABLES utilizes a twist and lock mechanism that is on the bottom center of each unit and when upright, the post is seated in an approximately ½ inch oval choke mold to keep in an elevated position. STACKABLES utilizes a twist and lock mechanism that is on the bottom center of each unit and to condense, a 90-degree turn in either direction allows the post to slide into or onto the oval post above or below. The collapsed STACKABLE units all fit in the bottom bowl/strainer. The posts slightly increase in diameter from the largest bowl/strainer to the smallest allowing each to fit inside the next one. There is also a small hole in the top of each post for cleaning and draining.

### BRIEF DESCRIPTION THE: DRAWINGS

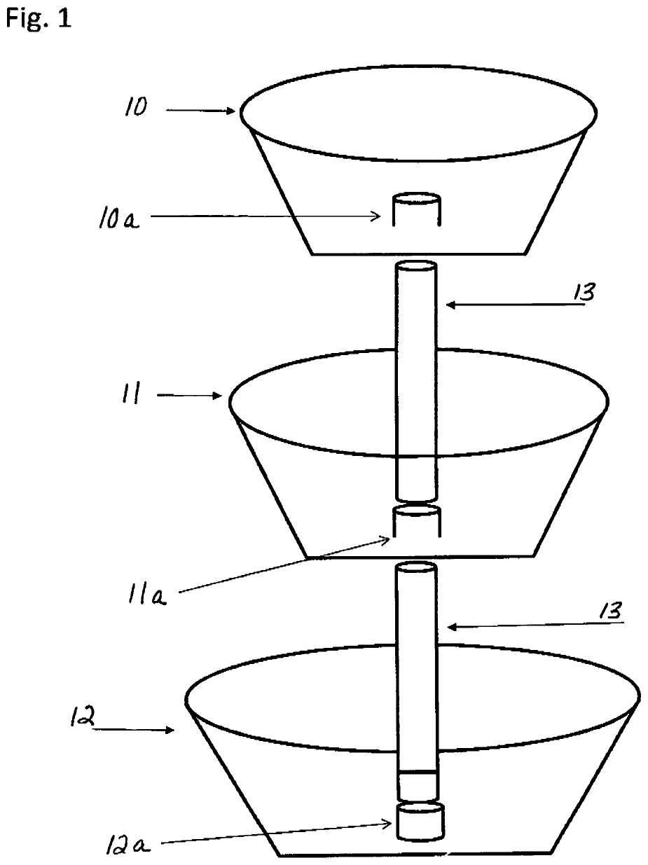

FIG. 1
10— Top bowl/strainer—Approx 7 inches in diameter, Approx 4 inch depth
10 a—Attached molded closed center stem
11—Center bowl/strainer—Approx 9 inches in diameter, Approx 4½ inch depth
11a—Attached molded closed center stem
12—Bottom bowl/strainer—Approx 11 inches in diameter, Approx 5 inch depth
12a—Attached molded closed center stem
13—5-7 inch removable post

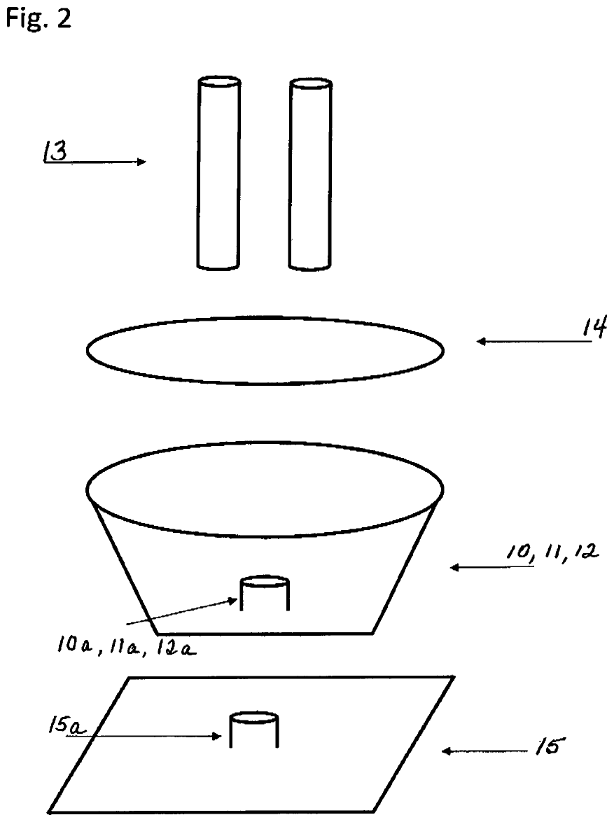

FIG. 2
13—2 posts, 5-7 inch posts
14—3 airtight lids
10,11,12—3 bowls/strainers
10a,11a,12a—Bowl design with closed molded center stem approx. 1 inch tall connects to interlocking posts to create stackable tower
15—Optional tray for a base with a closed, molded center stem

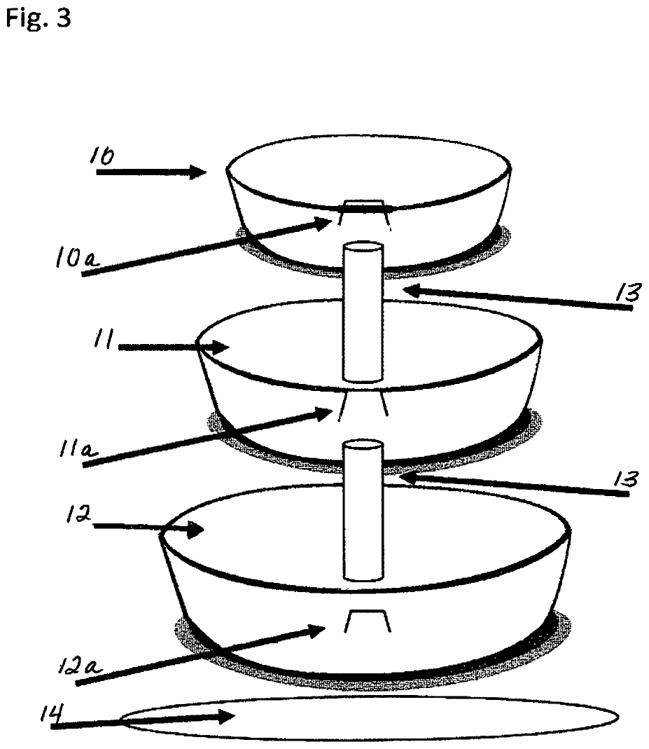

FIG. 3
10,11,12—Bowls/Strainers can be interchangeable with unique molded center stem
10a,11a,12a—Each tier has a molded center stem
14—Airtight sealed lids for each container

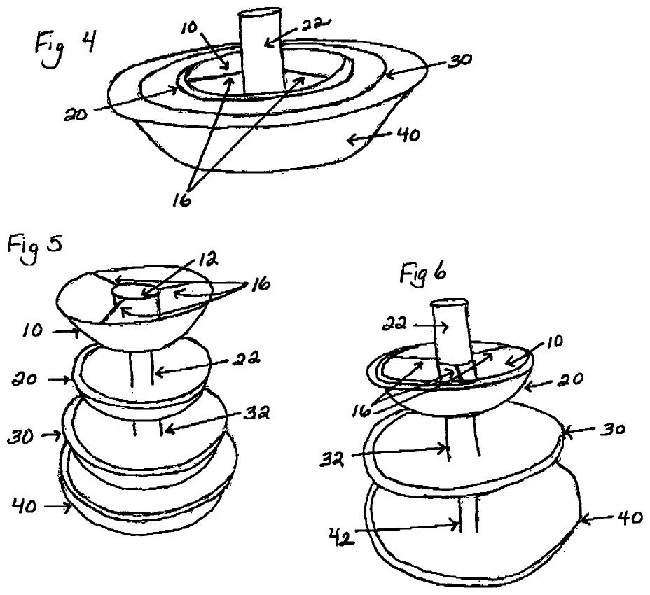

FIG. 4 4 STACKABLE units condensed into largest unit
10—Top bowl/strainer with dividers—Approximately 7 inches in diameter, Approximately 3 inch in depth
16—3 dividing walls equally spaced
20—Small bowl/strainer—Approximately 7 inches in diameter, Approximately 3 inches in depth
22—Attached molded closed center post with single 0.3 cm hole for drainage
30—Medium bowl/strainer—Approximately 10 inches in diameter, Approximately 3½ inches in depth
40—Large bowl/strainer—Approximately 12 inches in diameter, Approximately 4 inches in depth

FIG. 5 Side view of 4 STACKABLE units in tower
10—Top bowl/strainer with dividers—Approximately 7 inches in diameter, Approximately 3 inch in depth
12—Oval cutout
16—3 dividing walls equally spaced
20—Small bowl/strainer—Approximately 7 inches in diameter, Approximately 3 inches in depth
22—Attached molded closed center post with single 0.3 cm hole for drainage
30—Medium bowl/strainer—Approximately 10 inches in diameter, Approximately 3½ inches in depth
32—Attached molded closed center post with single 0.3 cm hole for drainage
40—Large bowl/strainer—Approximately 12 inches in diameter, Approximately 4 inches in depth

FIG. 6 Aerial view of 4 STACKABLE units in tower
10—Top bowl/strainer with dividers—Approximately 7 inches in diameter, Approximately 3 inch in depth
16—3 dividing walls equally spaced
20—Small bowl/strainer—Approximately 7 inches in diameter, Approximately 3 inches in depth
22—Attached molded closed center post with single 0.3 cm hole for drainage
30—Medium bowl/strainer—Approximately 10 inches in diameter, Approximately 3½ inches in depth
32—Attached molded closed center post with single 0.3 cm hole for drainage
40—Large bowl/strainer—Approximately 12 inches in diameter, Approximately 4 inches in depth
42—Attached molded closed center post with single 0.3 cm hole for drainage

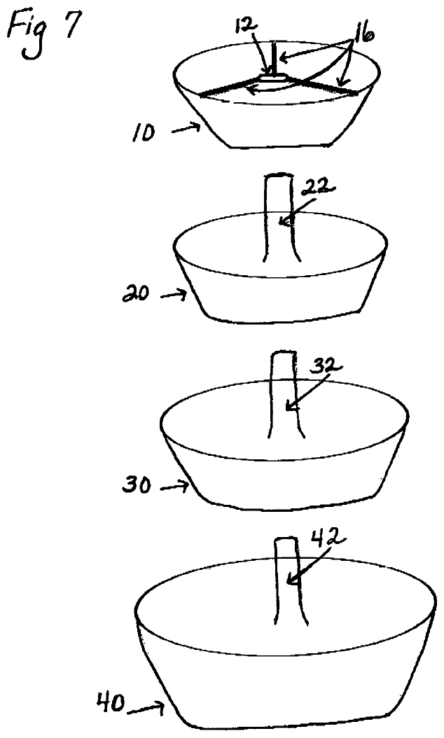

FIG. 7 Side view of each separated STACKABLE unit
10—Top bowl/strainer with dividers—Approximately 7 inches in diameter, Approximately 3 inch in depth
12—Oval cutout
16—3 dividing walls equally spaced
20—Small bowl/strainer—Approximately 7 inches in diameter, Approximately 3 inches in depth
22—Attached molded closed center post with single 0.3 cm hole for drainage.
30—Medium bowl/strainer—Approximately 10 inches in diameter, Approximately 3½ inches in depth
32—Attached molded closed center post with single 0.3 cm hole for drainage
40—Large bowl/strainer—Approximately 12 inches in diameter, Approximately 4 inches in depth
42—Attached molded closed center post with single 0.3 cm hole for drainage

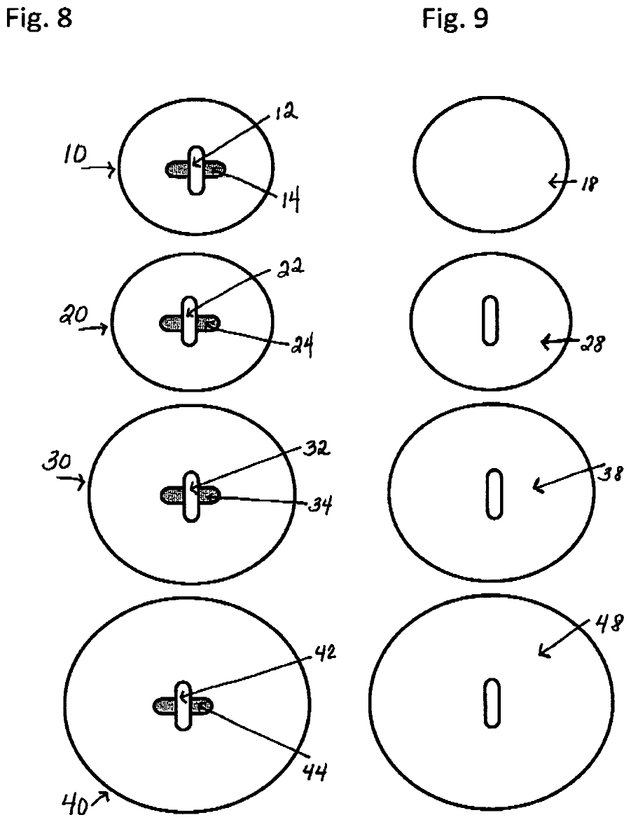

FIG. 8 Bottom view of each separated STACKABLE unit
10—Bottom view of top bowl/strainer with dividers—Approximately 7 inches in diameter, Approximately 3 inch in depth
12—Bottom view of oval cutout
14—Bottom view of approximately ½ inch oval choke
20—Bottom view of small bowl/strainer—Approximately 7 inches in diameter, Approximately 3 inches in depth
22—Bottom view of attached molded closed center post with single 0.3 cm hole for drainage
24—Bottom view of approximately ½ inch oval choke
30—Bottom view of medium bowl/strainer—Approximately 10 inches in diameter, approximately 3½ inches in depth
32—Bottom view of attached molded closed center post with single 0.3 cm hole for drainage
34—Bottom view of approximately ½ inch oval choke
40—Bottom view of large bowl/strainer—Approximately 12 inches in diameter, approximately 4 inches in depth
42—Bottom view of attached molded closed center post with single 0.3 cm hole for drainage
44—Bottom view of approximately ½ inch oval choke

FIG. 9 Separated lids for each STACKABLE unit
18—Airtight lid for top bowl/strainer with dividers—approximately 7 inched in diameter
28—Airtight lid for small bowl/strainer with cutout for post—approximately 7 inches in diameter
38—Airtight lid for medium bowl/strainer with cutout for post—approximately 10 inches in diameter
48—Airtight lid for large bowl/strainer with cutout for post—approximately 12 inches in diameter

### DETAILED DESCRIPTION OF THE INVENTION

(FIG. 1A, 2A, 3A) STACKABLES is consisted of 3 bowls or strainers, 2 posts, and 3 airtight lids. With only a working prototype, we have engineers finding the best plastics to be used to effectively create a strong, durable material. Materials will be safe for foods, as well as dishwasher safe and microwavable.

(FIG. 1A, 2A, 3A) Each bowl/strainer has a molded in, closed center stem (approximately 1 inch tall). Each post (between 5-7 inches tall) will fit securely onto the stem to create a tower. The post will fit securely in the base of the bowl of the next level. Each bowl will have an airtight lid. A tray for the bottom is optional.

(FIG. 4,5,6) STACKABLES is consisted of 3 bowls/strainers, 1 bowl/strainer with dividers, and 4 airtight lids. The collapsed STACKABLE units all fit in the bottom bowl/strainer. The posts slightly increase in diameter from the largest bowl/strainer to the smallest allowing each to fit inside the next one. There is also a small hole in the top of each post for cleaning and draining. With only a working prototype, we have engineers finding the best plastics to be used to effectively create a strong, durable material. Materials will be safe for foods, as well as dishwasher safe and microwavable.

(FIG. 7,8,9) Each of the 3 bowls/strainers has a molded, closed center post with a small drain hole for cleaning. STACKABLES utilizes a twist and lock mechanism that is on the bottom center of each unit and when upright, the post is seated in an approximately ½ inch oval choke mold to keep in an elevated position. STACKABLES utilizes a twist and lock mechanical that is on the bottom center of each unit and to condense, a 90-degree turn in either direction allows the post to slide into or onto the oval post above or below. Each post will fit securely onto the above post to create a tower. The post will fit securely in the base of the bowl of the next level. Each bowl will have an airtight lid.

STACKABLES are a space saving tower that can be used to prepare, thaw, clean and serve food or hold items.

Each of the bowls have a unique stem and post system that is simple for the consumer to assemble.

While still in the beginning stages of development, the uniqueness of the “STACKABLES” tower lies in the individual units (bowls, strainers, and optional trays as a base). Each unit has a closed stem molded in the center of each unit. This stem will connect with larger attachable posts to build height and stability. The molded center stem in each unit is slightly wider at the base (for the post to be inserted) and narrower at the top (so the post will fit securely on it).

The units of “STACKABLES” are interchangeable. “STACKABLES” are to serve food in any room to save space (kitchen counters, coffee tables, dinner table, etc.).

“STACKABLES” for the kitchen sink have an attachment for the kitchen sink to utilize that space for cleaning, preparing, thawing and serving food.

Three to four levels of this tower use bowls and/or strainers. Units have a unique twist and lock mechanism molded to the unit that requires no assembly.

While still in the beginning stages of development, the uniqueness of the STACKABLES tower lies in the individual units (bowls or strainers). Each unit has a closed post molded in the center of each unit with a small drain hole for cleaning and in the dishwasher. This post will set in or on the posts of the other units to build height and stability. The molded center post in each unit is slightly smaller in diameter than each unit above it. STACKABLES also has the option to use 1, 2, 3 or 4 units at any time, just by keeping the larger units below and building up with (a) smaller unit(s). STACKABLES are to hold food or items in any room to save space

We are currently investigating multiple manufacturers to create a final prototype. These engineers will decide the best plastics materials and precise measurements of the units (bowls, strainers etc.) and which length of the center posts will best work on the STACKABLES tower.

Materials used and specific design increase proper health sanitations for food handling. Materials are dishwasher safe.

Plastic materials are utilized for the residential use of the STACKABLES tower and stainless-steel materials are used for those in commercial use. (Restaurants, food industry, hotels, etc.).

What is claimed is:

1. A space saving tower of stackable bowls, comprising a plurality of bowls, each of said plurality of bowls capable of stacking upon one another, wherein each of the plurality of bowls has a different diameter, wherein a bowl with the smallest diameter is on top of the tower and a bowl with the largest diameter is on the bottom of the tower, wherein each of the plurality of bowls includes a center post which twists and locks into an adjoining bowl.

2. The space saving tower of stackable bowls of claim 1, wherein the tower is comprised of a first bowl, a second bowl, a third bowl and a fourth bowl.

3. The space saving tower of stackable bowls of claim 2, wherein the first bowl contains three dividing walls.

4. The space saving tower of stackable bowls of claim 2, wherein the first and second bowls have a diameter of about 7 inches and are about 3 inches deep.

5. The space saving tower of stackable bowls of claim 2, wherein the third bowl has a diameter of about 10 inches and is about 3.5 inches deep.

6. The space saving tower of stackable bowls of claim 2, wherein the fourth bowl has a diameter of about 12 inches and is about 4 inches deep.

7. The space saving tower of stackable bowls of claim 1, wherein each of the plurality of bowls has a molded closed center post having a hole therein for drainage.

8. The space saving tower of stackable bowls of claim 1, wherein the tower is configured to be upright or collapsible, wherein when the tower is collapsible, all of the bowls fit into the bowl located on the bottom.

9. The space saving tower of stackable bowls of claim 1, wherein each of the plurality of bowls has a twist and lock mechanism located on the bottom center of each of the bowls, wherein when the tower is upright, the post is seated in about a 0.5 inch oval choke molded to keep in an elevated position, and when the tower is condensed, a 90-degree turn of the twist and lock mechanism in either direction allows the post of each of the bowls to slide into the post above or below.

10. The space saving tower of stackable bowls of claim 1, wherein each of the plurality of bowls has an airtight lid.
